(19) United States
(12) Patent Application Publication
(10) Pub. No.: US 2025/0050243 A1
(43) Pub. Date: Feb. 13, 2025

(54) REACTION AND SEPARATION APPARATUS

(71) Applicant: BIOLY LIMITED, Nottingham (GB)

(72) Inventor: Billy Tyler BOOTLE-TOPLEY, Nottingham (GB)

(21) Appl. No.: 18/718,180

(22) PCT Filed: Dec. 7, 2022
(86) PCT No.: PCT/GB2022/053109

§ 371 Date: Jun. 10, 2024

(30) Foreign Application Priority Data
Dec. 10, 2021 (GB) 2117858.7

(51) Int. Cl. B01D 21/00; B01D 21/08; B01D 21/24; B01D 33/048; B01D 33/06; B01D 33/46; B01D 36/04; C02F 1/00; C02F 3/12; C02F 11/123; C02F 11/126; C02F 101/16; C02F 103/20

(52) U.S. Cl. CPC B01D 21/0012; B01D 21/0042; B01D 21/0051; B01D 21/0087; B01D 21/08; B01D 21/2444; B01D 21/245; B01D 33/048; B01D 33/06; B01D 33/463; B01D 36/04; C02F 3/1236; C02F 3/1278; C02F 11/123; C02F 11/126; C02F 2001/007; C02F 2101/16; C02F 2103/20

(57) ABSTRACT

There is provided a filtration system comprising a reaction and separation apparatus (2) for processing a solid-liquid mixture (4) to separate solids from liquid, the reaction and separation apparatus (2) comprising:
a tank (6) comprising an inlet (8) and an outlet (10), the inlet (8) configured for receiving the solid-liquid mixture (4) into the tank (6), the outlet (10) configured for permitting liquid to exit the tank (6); and
a sedimentation device (16) including a liquid conduit (18), the liquid conduit (18) having a first end (20) and a second end (22), the first end (20) configured to be in liquid communication with the outlet (10), the second end (22) configured for dispensing liquid from the liquid conduit (18), wherein the second end (22) is positioned higher than the first end (20) so that the liquid conduit (18) extends from the first end (20) to the second end (22) along a vertical axis or along an inclined axis relative to the horizontal,
wherein the filtration system further comprises a preparatory filter (642) configured to, in use, receive an inflow liquid (644) from an external source and separate the inflow liquid (644) into the solid-liquid mixture (4) and a filtered liquid (646), wherein the preparatory filter (642) is configured to dispense the solid-liquid mixture (4) into the tank (6) via the inlet (8).

This invention relates to a reaction and separation apparatus, a method for processing a solid-liquid mixture to separate solids from liquid using the reaction and separation apparatus, a filtration system and a method for processing an inflow liquid using the filtration system.

It is known to use a two-tank assembly comprising two distinct tanks for reaction and separation systems such as activated sludge systems. A first of the two tanks acts as a reaction tank and a second of the two tanks acts as a settling tank.

According to a first aspect of the invention, there is provided a reaction and separation apparatus for processing a solid-liquid mixture to separate solids from liquid, the reaction and separation apparatus comprising:
a tank comprising an inlet and an outlet, the inlet configured for receiving the solid-liquid mixture into the tank, the outlet configured for permitting liquid to exit the tank;
a reaction device operable to cause and/or accelerate one or more reactions within the solid-liquid mixture within the tank; and
a sedimentation device including a liquid conduit, the liquid conduit having a first end and a second end, the first end configured to be in liquid communication with the outlet, the second end configured for dispensing liquid from the liquid conduit, wherein the second end is positioned higher than the first end so that the liquid conduit extends from the first end to the second end along a vertical axis or along an inclined axis relative to the horizontal.

In use, solid-liquid mixture, i.e. a liquid carrying solids in suspension, is added to the tank. As the level of solid-liquid mixture in the tank rises, the level of liquid will correspondingly rise in the liquid conduit. Due to the liquid conduit extending from the outlet of the tank in an upwards direction, either vertically or at an incline relative to the horizontal, solids carried by the liquid into the liquid conduit will settle, due to the effect of gravity, back towards the tank via the outlet. This in turn reduces the quantity of solids carried by the liquid as it approaches the higher second end. When sufficient solid-liquid mixture is added to the tank, the liquid in the liquid conduit will reach the second end and any further addition of solid-liquid mixture to the tank will cause liquid to be dispensed from the second end.

Accordingly, by way of the invention, a solid-liquid mixture may be processed to separate solids from liquid using a reaction and separation apparatus with a single tank configuration. Furthermore, in the same tank, growth of microorganisms is caused and/or accelerated by the reaction device. The growing microorganisms break down solids and release nutrients into the liquid. These nutrients are dissolved into the liquid itself, resulting in the dispensing of a nutrient-rich liquid from the second end of the liquid conduit. Meanwhile, the microorganisms flocculate to form biological flocs that settle more readily than the solids originally carried by the liquid. Settled biological flocs may form activated sludge that collects towards a base of the tank.

Microorganisms may include bacteria, fungi, archaea, protists or a combination thereof.

The ability to encourage the breakdown of solids through microorganism growth, thereby enriching the liquid with nutrients, and separating the remaining solids from the liquid using the same tank allows the reaction and separation apparatus to fit into a smaller space when compared to conventional two-tank apparatus assemblies. This is particularly beneficial in locations, such as farms, where space is at a premium. The invention may also benefit from reduced manufacturing costs due to the smaller apparatus, the lower number of required tanks, cheaper transportation of the apparatus, and easier and cheaper installation. Moreover, the configuration of the reaction and separation apparatus enables the reaction and separation apparatus to be carried out in an energy-efficient manner when compared to conventional two-tank apparatus assemblies.

The inlet of the tank may be positioned at the top of the tank, such as in an open top tank, or may be positioned at the side of the tank, or may be positioned at a base of the tank.

The liquid conduit may include at least one tube. The total number of tubes and the configuration of the or each tube (such as cross-sectional shape, internal diameter/width, length and angle of inclination from the horizontal) may be selected to optimise the performance of the sedimentation device for a given application. For example, the degree of separation of solids from liquid could be maximised for a particular solid-liquid mixture composition.

Each tube may have any suitable cross-sectional shape, such as circular, rectangular or hexagonal for example. A plurality of tubes may be bundled together to extend, preferably parallel or substantially parallel to one another, from the first end to the second end of the liquid conduit.

The liquid conduit may include at least one lamellar separation element. The or each lamellar separation element may be a plate or tubular element that extends along an inclined axis relative to the horizontal. In some embodiments of the invention, the or each lamellar separation element may extend along an axis inclined between 7 degrees and 70 degrees relative to the horizontal. An inclined surface of the or each lamellar separation element provides a settling surface where solids from the solid-liquid mixture accumulate until the collected solids are heavy enough to slide down the inclined surface back to the first end of the liquid conduit and into the outlet of the tank. In this way the or each lamellar separation element increases the sedimentation effectiveness of the reaction and separation apparatus.

The liquid conduit may include a plurality of lamellar separation elements that provide a plurality of surfaces on which solids may settle, accumulate and then slide down towards the first end of the liquid conduit. The plurality of lamellar separation elements may be configured to form narrow conduits through which the liquid flows in a laminar manner. For example, plate-like lamellar separation elements may be positioned in parallel with each other, where each gap between neighbouring lamellar separation elements is sized to encourage laminar fluid flow between the plate-like lamellar separation elements. Similarly, tube-like lamellar separation elements may have internal diameters that are selected to encourage laminar fluid flow through the tube-like lamellar separation elements. By promoting laminar fluid flow and thereby minimising turbulence, the sedimentation effectiveness of the reaction and separation apparatus is further enhanced.

The liquid conduit may have more than two ends. For example, the liquid conduit may comprise an auxiliary conduit section which is distinct from a main body of the liquid conduit extending between the first and second ends. The auxiliary conduit section may extend from the main body to a third end of the liquid conduit, and the auxiliary conduit section may function to, for example, return settled solids back to the tank. This would reduce the burden on the main body of the liquid conduit to return settled solids to the tank while also allowing liquid to rise up through the liquid conduit.

In embodiments of the invention, the first end of the liquid conduit may be directly coupled to the outlet of the tank.

In embodiments of the invention, the reaction device may comprise a mixer positioned in or relative to the tank so that, in use, the mixer is operable to mix the solid-liquid mixture within the tank.

Due to the heterogeneous nature of solid-liquid mixtures, materials of different density are liable to separate from one another unless an external force mixes the solid-liquid mixture. This means that different compounds/nutrients/microorganisms in the solid-liquid mixture are less exposed to one another and reactions between those elements slow down or stop occurring altogether. Mixing of the solid-liquid mixture causes the various compounds, materials, nutrients and microorganisms to mix with one another and thereby causes one or more reactions to take place and/or increases the rate of those reactions.

The mixer may be any suitable device for transferring kinetic energy to the solid-liquid mixture in the tank. For example, the mixer may be a mechanical mixer comprising an automated paddle, stirrer or agitator. The mixer may also generate movement of the solid-liquid mixture through other, non-mechanical means such as by releasing a fluid into the tank whereby the movement of the fluid through the tank causes movement of the solid-liquid mixture.

Accordingly, in embodiments of the invention, the reaction device may comprise an aerator for releasing a gas, the aerator positioned in or relative to the tank so that, in use, the aerator is operable to release the gas into the tank.

The aerator may be any suitable device configured for releasing a gas such as air, oxygen, an oxygen-rich mixture or even a gas containing no oxygen. An example of such a device is an air diffuser configured for releasing a stream of air bubbles into the solid-liquid mixture in the tank.

In addition to mixing the solid-liquid mixture, release of a gas containing oxygen by the aerator into the solid-liquid mixture acts to aerate the solid-liquid mixture, thereby encouraging aerobic growth of microorganisms in the solid-liquid mixture to further break down the solids and release nutrients into the liquid. As mentioned above, these nutrients are dissolved into the liquid itself, resulting in the dispensing of a nutrient-rich liquid from the second end of the liquid conduit. Meanwhile, the microorganisms flocculate to form biological flocs that settle more readily than the solids originally carried by the liquid. Settled biological flocs may form activated sludge that collects towards a base of the tank.

If a gas with no oxygen is used, then anaerobic reactions may occur rather than aerobic reactions.

In embodiments of the invention, the aerator may be positioned at or towards a base of the tank and may be operable to release gas in an upward direction. In such embodiments of the invention, the released gas may travel upwards through the entirety, or a substantial portion, of the depth of the solid-liquid mixture in the tank by virtue of the gas being less dense than the solid-liquid mixture. The positioning of the aerator at or towards the base of the tank increases the duration of contact between the released gas and the solid liquid-mixture, thereby increasing the efficiency of aeration that may be achieved.

The reaction device may be positioned in or relative to the tank so that, in use, the reaction device is operable to induce circulation of the solid-liquid mixture around at least a part of the tank and past the outlet. For example, in embodiments of the invention wherein the reaction device is an aerator, the aerator may be operable to release gas in a direction that induces circulation of the solid-liquid mixture around at least a part of the tank and past the outlet.

Over time, settled solids from the liquid conduit may accumulate in the vicinity of the outlet and thereby cause clogging of the liquid conduit. This in turn may increase the flow rate of liquid in the liquid conduit to the extent that the sedimentation effectiveness of the reaction and separation apparatus is adversely affected. By circulating the solid-liquid mixture past the outlet, settled solids in the vicinity of the outlet are flushed away to prevent clogging of the liquid conduit. The circulation of the solid-liquid mixture past the outlet therefore provides the reaction and separation apparatus with a self-cleaning mechanism for cleaning the liquid conduit. This obviates the need for a separate cleaning mechanism, such as an auger or a mechanical scraper, that would add size and cost to the apparatus.

In some embodiments of the invention, the reaction device may be eccentrically positioned relative to a central axis passing through a base of the tank. The eccentric position of the reaction device may be selected to optimise the circulation path of the solid-liquid mixture in the tank and past the outlet so as to improve self-cleaning effectiveness.

To further improve the self-cleaning of the liquid conduit, the apparatus may further comprise a baffle positioned in the tank to direct the circulating solid-liquid mixture to flow past the outlet. The baffle may encourage a more laminar flow of the solid-liquid mixture past the outlet, thereby providing better control over the flow direction and flow rate of the solid-liquid mixture flowing past the outlet to provide consistent self-cleaning.

The baffle may be positioned in the tank to direct the circulating solid-liquid mixture to flow in a downward direction past the outlet. In such embodiments of the invention, the downward flow of solid-liquid mixture past the outlet complements the effect of gravity on the solids settling at the first end of the liquid conduit.

The baffle may extend vertically or substantially vertically relative to a base of the tank. This may improve the degree to which solid-liquid mixture flows past the outlet, particularly in a downwards direction, i.e. towards the base. Also, if the aerator is positioned to release gas in an upwards direction, providing a vertical or substantially vertical baffle between the aerator and the outlet may improve the degree to which the baffle shields the outlet from gas released by the aerator. This is particularly the case if the aerator is positioned eccentrically relative to a central axis passing through a base of the tank and substantially at an opposite side of the tank to the outlet.

The baffle may be re-configurable to change its size or shape. The baffle may therefore be re-configured to adapt to varying system parameters such as the flow rate through the tank or the composition of the solid-liquid mixture.

In embodiments of the invention in which the reaction device is an aerator, the baffle may additionally, or alternatively, be positioned in the tank between the aerator and the outlet to prevent aeration of liquid inside the liquid conduit by the aerator. Aeration of liquid inside the liquid conduit would lower the density of the liquid inside the liquid conduit, which could reduce the efficiency at which solids settle in the liquid conduit. Such aeration would also introduce turbulence to the liquid which would further prevent solids from settling effectively. Therefore, positioning the baffle to prevent aeration of liquid inside the liquid conduit improves the settling performance of the liquid conduit.

Also, the quantity of solids inside the liquid conduit will be lower than the quantity of solids in the tank so any microorganism growth promoted by gas entering the liquid conduit would be less effective than microorganism growth promoted by gas within the tank. In other words, gas that enters the liquid conduit may be considered inefficient or wasted in terms of breaking down solids in the reaction and separation apparatus. Therefore, preventing aeration of liquid into the liquid conduit improves the overall performance of the reaction and separation apparatus.

In embodiments of the invention, the tank and the liquid conduit may be configured to have a common wall separating the tank and the liquid conduit, and the first end of the liquid conduit may be configured to be in liquid communication with the outlet through the common wall.

In such embodiments of the invention, the reaction and separation apparatus may have a simplified construction that involves the liquid conduit and the tank having a common wall rather than being separate and distinct structures. This allows the reaction and separation apparatus to be designed to be more compact, easier to transport or both, thus making more efficient use of space.

The liquid conduit may be arranged to extend inside and through the tank. For example, rather than having the liquid conduit extend away from the tank, the liquid conduit could extend through the tank to save space. The liquid conduit extending through the tank could also be configured as a barrier or baffle that causes beneficial turbulence in the tank to encourage mixing of microorganisms throughout the solid-liquid mixture and/or that serves to distribute gas more evenly through the solid-liquid mixture.

The tank may further comprise a solids outlet configured for dispensing solids settled at or towards a base of the tank. This allows settled solids to be removed from the tank to avoid build-up to the extent that they might clog the outlet. The solids settled at the bottom of the tank, or activated sludge, may also be a useful product for fertilisation of plants either directly or following a mineralisation process.

Settled solids may flow to the region of the tank below the reaction device as a result of the circulation of liquid around the tank. The solids outlet may therefore be positioned in the tank so that it is below the reaction device when the reaction and separation apparatus is in use, thereby improving the efficacy with which solids may be removed.

The reaction and separation apparatus may include a single tank, i.e. only a single tank instead of a plurality of tanks, such as the conventional two-tank assembly required by known reaction and separation systems. Such embodiments of the invention may be more compact, easier to transport and cheaper to manufacture than known reaction and separation systems.

According to a second aspect of the invention, there is provided a filtration system comprising a reaction and separation apparatus according to any one of the first aspect of the invention and its embodiments, the filtration system further comprising a preparatory filter configured to, in use, receive an inflow liquid from an external source and separate the inflow liquid into a solid-liquid mixture and a filtered liquid, wherein the preparatory filter is configured to dispense the solid-liquid mixture into the tank via the inlet.

The features and advantages of the first aspect of the invention and its embodiments apply mutatis mutandis to the second aspect of the invention and its embodiments.

The configuration of the filtration system of the invention enables an initial filtration process to be carried out by the preparatory filter before the reaction and separation process is carried out by the reaction and separation apparatus. The filtration system may be provided as a single unit that is simpler to install and avoids the need to combine separate filtering, reaction and separation equipment, each carrying out its respective process. The preparatory filter may be provided with the reaction and separation apparatus in a single unit or may be separate from the reaction and separation apparatus but readily connectible to the reaction and separation apparatus via, for example, pipework. Additionally, the filtration system may comprise: a plurality of reaction and separation apparatus that are operatively connected to a single preparatory filter; or a single reaction and separation apparatus that is operatively connected to a plurality of preparatory filters.

The liquid conduit may be configured to dispense liquid from the second end upstream of the preparatory filter so that the liquid dispensed from the liquid conduit may undergo filtration by the preparatory filter. The liquid dispensed from the liquid conduit may therefore mix with new inflow liquid and undergo an additional ‘polishing’ filtration. During the additional filtration, any solids remaining in the liquid dispensed from the liquid conduit will be separated from the liquid and will be returned to the tank for processing. Meanwhile, the nutrient-rich liquid dispensed from the liquid conduit will pass through the preparatory filter as the filtered liquid.

The preparatory filter may comprise a filtration element and a solids removal device, the filtration element configured to separate the inflow liquid into solids and the filtered liquid, the solids removal device operable to dislodge solids from the filtration element so that the solids may be mixed with a liquid to provide a solid-liquid mixture for dispensing into the tank via the inlet.

Accordingly, the process of filtering and dispensing the filtered water may be separated from the process of dislodging solids from the filtration element and providing a solid-liquid mixture to be dispensed into the tank. For example, a batch process may be applied wherein each of these processes are carried out during different periods of time. Alternatively a continuous process can be applied if the filtration element is movable, for example, and the liquid filtering process can be carried out in one region while the solids dislodging process can be carried out in a separate region. For example, solids may be dislodged from the filtration element directly into the inlet of the tank. The ability to separate these processes enables optimisation of the filtration system for a given application.

In embodiments of the invention, the solids removal device may comprise a liquid source operable to direct a flow of washing liquid at the filtration element to dislodge the solids from the filtration element to provide a solid-liquid mixture that is dispensed into the tank via the inlet into the tank, wherein the solid-liquid mixture comprises a mixture of the washing liquid and the dislodged solids.

This not only allows solids to be reliably dislodged from the filtration element but also cleans the filtration element without risk of damage or wear that might be caused by, for example, a mechanical scraper. This feature also allows for the composition of the solid-liquid mixture to be configured for a particular application. For example, the density of solids in the solid-liquid mixture could be varied by varying the flow rate of wash liquid. Also, the washing liquid could be configured, with the addition of additives for example, to improve processing of the solids in the tank.

The liquid source may be any device suitable for directing a flow of liquid at the filtration element, such as a spraying device (e.g. a spray bar) for example.

In other embodiments of the invention, the solids removal device may comprise a mechanical solids removal device, such as a scraper, or any other type of solids removal device suitable for dislodging solids from the filtration element.

The filtration element may be a belt filter. The belt filter may be in the form of an endless belt that revolves around a conveyor assembly. The conveyor assembly may extend the endless belt over, at least, a first region and a second region. In the first region, the belt filter may be configured to receive inflow liquid, and optionally liquid dispensed from the liquid conduit. Liquid will drain through the endless belt in this region, leaving solids caked on the endless belt. The solids will then be conveyed by the conveyor assembly to the second region, in which the liquid source may direct wash liquid at the solids to dislodge them. The second region may be positioned over the tank so the solid-liquid mixture formed by the wash liquid and dislodged solids may be dispensed directly into the inlet of the tank.

Alternatively, the filtration element may be a drum filter. The drum filter may include a cylindrical drum that rotates about a central rotational axis passing through the drum. In a first region of the drum filter, which the drum rotates through, the drum filter may be configured to receive inflow liquid, and optionally liquid dispensed from the liquid conduit. Liquid will drain through the drum in this region, leaving solids caked on the drum. The solids will then be rotated around the drum filter by the drum to a second region of the drum filter. In the second region, the liquid source may direct wash liquid at the solids to dislodge them and the solid-liquid mixture formed by the wash liquid and dislodged solids may be dispensed into the inlet of the tank, for example via a trough extending from the second region of the drum filter to the inlet of the tank.

In embodiments of the invention, the filtration system may further comprise a biofilter for processing ammonia into nitrates, wherein the preparatory filter may be configured to dispense the filtered liquid into the biofilter.

This may be particularly beneficial in aquaculture or aquaponics applications in which the inflow liquid received by the filtration system may have high ammonia levels that would be harmful to plants watered using the filtered liquid dispensed by the preparatory filter.

In embodiments of the invention, the filtration system may comprise a plurality of preparatory filters connected to a single reaction and separation apparatus according to any one of the first aspect of the invention and its embodiments. In alternate embodiments of the invention, the filtration system may comprise a plurality of reaction and separation apparatuses, according to one or more of the first aspect of the invention and its embodiments, connected to a single preparatory filter. In further embodiments of the invention, the filtration system may comprise a plurality of preparatory filters and a plurality of reaction and separation apparatuses, according to one or more of the first aspect of the invention and its embodiments, that are interconnected with one another directly or indirectly.

According to a third aspect of the invention, there is provided a filtration system comprising a reaction and separation apparatus according to any one of the first aspect of the invention and its embodiments, the filtration system further comprising a biofilter for processing ammonia into nitrates, wherein the liquid conduit is configured to dispense liquid from its second end into the biofilter.

The features and advantages of the aforementioned aspects of the invention and their embodiments apply mutatis mutandis to the third aspect of the invention and its embodiments.

In other words, the reaction and separation apparatus may be combined with a biofilter, with or without a preparatory filter. This may be useful for applications where an inflow liquid to be processed is already ready for reaction and separation, e.g. the inflow liquid does not require preparatory filtration or was pre-filtered before delivery to the filtration system, thus obviating the need for the preparatory filter.

As with the preparatory filter, the biofilter may be provided with the reaction and separation apparatus in a single unit or may be separate from the reaction and separation apparatus but readily connectible to the reaction and separation apparatus via, for example, pipework. Additionally, the filtration system may comprise: a plurality of reaction and separation apparatus that are operatively connected to a single biofilter; or a single reaction and separation apparatus that is operatively connected to a plurality of biofilters.

In this aspect of the invention, the liquid dispensed from the liquid conduit is provided to the biofilter for processing ammonia into nitrates. Again, this may be particularly beneficial in aquaculture or aquaponics applications in which the solid-liquid mixture received by the reaction and separation apparatus may have high ammonia levels that would be harmful to plants watered using the liquid dispensed by the liquid conduit.

According to a fourth aspect of the invention, there is provided a filtration system comprising a reaction and separation apparatus, the reaction and separation apparatus comprising:
a tank comprising an inlet and an outlet, the inlet configured for receiving the solid-liquid mixture into the tank, the outlet configured for permitting liquid to exit the tank; and
a sedimentation device including a liquid conduit, the liquid conduit having a first end and a second end, the first end configured to be in liquid communication with the outlet, the second end configured for dispensing liquid from the liquid conduit, wherein the second end is positioned higher than the first end so that the liquid conduit extends from the first end to the second end along a vertical axis or along an inclined axis relative to the horizontal;
wherein the filtration system further comprises a preparatory filter configured to, in use, receive an inflow liquid from an external source and separate the inflow liquid into a solid-liquid mixture and a filtered liquid, wherein the preparatory filter is configured to dispense the solid-liquid mixture into the tank via the inlet.

The features and advantages of the aforementioned aspects of the invention and their embodiments apply mutatis mutandis to the fourth aspect of the invention and its embodiments.

The fourth aspect of the invention is similar to the second aspect of the invention except that, rather than comprising a reaction and separation apparatus according to the first aspect of the invention, the filtration system comprises a reaction and separation apparatus which comprises a tank and sedimentation device but no reaction device. The reaction and separation apparatus may therefore be considered to be passive in that one or more reactions are not actively caused to occur or accelerated by means of a reaction device.

Despite there being no reaction device, it is still possible for reactions to occur within the tank, albeit potentially more slowly than if a reaction device were used. Further, some mixing of the solid-liquid mixture may be caused, inherently, by the force of solid-liquid mixture entering the tank, for example. There may also be aeration of the solid-liquid mixture, for example if the tank is unsealed and open to the environment.

In known aquaculture or aquaponics systems, for example, waste water is filtered and the resulting sludge captured by the filter is discarded, wasting the various nutrients trapped within it.

Combining a filter with a passive reaction and separation apparatus greatly reduces the wastage of such systems with very small, if any, additional running costs because the sludge is provided with an opportunity to break down in the tank without requiring energy to operate a reaction device. Further, the nutrient-rich liquid in the tank can be returned to the filter, as described with respect to the second aspect of the invention, so that the filtered liquid comprises a much higher level of nutrients than if no passive reaction and separation apparatus were used.

It is to be understood that various features of the first, second and third aspects of the invention may be incorporated mutatis mutandis into the fourth aspect of the invention. For example, the liquid conduit of the passive reaction and separation apparatus may be configured in the same way as the liquid conduit defined with respect to the first aspect of the invention. As a further example, a biofilter such as those described with respect to the second and third aspects of the invention could be incorporated into the filtration system of the fourth aspect of the invention.

According to a fifth aspect of the invention, there is provided a method for processing a solid-liquid mixture to separate solids from liquid using a reaction and separation apparatus according to any one of the first aspect of the invention and its embodiments, the method comprising the steps of:
providing solid-liquid mixture into the tank;
causing and/or accelerating one or more reactions within the solid-liquid mixture within the tank using the reaction device;
adding more solid-liquid mixture into the tank to cause the aerated solid-liquid mixture to exit the tank via the liquid conduit; and
dispensing liquid from the second end of the liquid conduit.

The features and advantages of the aforementioned aspects of the invention and their embodiments apply mutatis mutandis to the fifth aspect of the invention and its embodiments.

By way of the method of the invention, one or more reactions within a solid-liquid mixture may be caused and/or accelerated and the solid-liquid mixture may be separated into solids and liquid using a single tank rather than using two distinct reaction and separation tanks, thereby providing cost and space savings.

According to a sixth aspect of the invention, there is provided a method for processing an inflow liquid using a filtration system according to any one of the second aspect of the invention and its embodiments, the method comprising the steps of:
providing inflow liquid into the preparatory filter;
separating the inflow liquid into a solid-liquid mixture and a filtered liquid using the preparatory filter;
providing the solid-liquid mixture into the tank;
causing and/or accelerating one or more reactions within the solid-liquid mixture within the tank using the reaction device;
adding more solid-liquid mixture into the tank to cause the aerated solid-liquid mixture to exit the tank via the liquid conduit; and
dispensing liquid from the second end of the liquid conduit.

The features and advantages of the aforementioned aspects of the invention and their embodiments apply mutatis mutandis to the sixth aspect of the invention and its embodiments.

The method of the invention may be carried out using a single unit and is thereby simpler than known methods for processing an inflow liquid that require separate equipment for filtering the inflow liquid, causing and/or accelerating one or more reactions in a solid-liquid mixture obtained from that filtration and then separating the solid-liquid mixture into solids and liquid.

It will be appreciated that the use of the terms “first” and “second”, and the like, in this patent specification is merely intended to help distinguish between similar features and is not intended to indicate the relative importance of one feature over another feature, unless otherwise specified.

Within the scope of this application it is expressly intended that the various aspects, embodiments, examples and alternatives set out in the preceding paragraphs, and the claims and/or the following description and drawings, and in particular the individual features thereof, may be taken independently or in any combination. That is, all embodiments and all features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

Preferred embodiments of the invention will now be described, by way of non-limiting examples, with reference to the accompanying drawings in which:

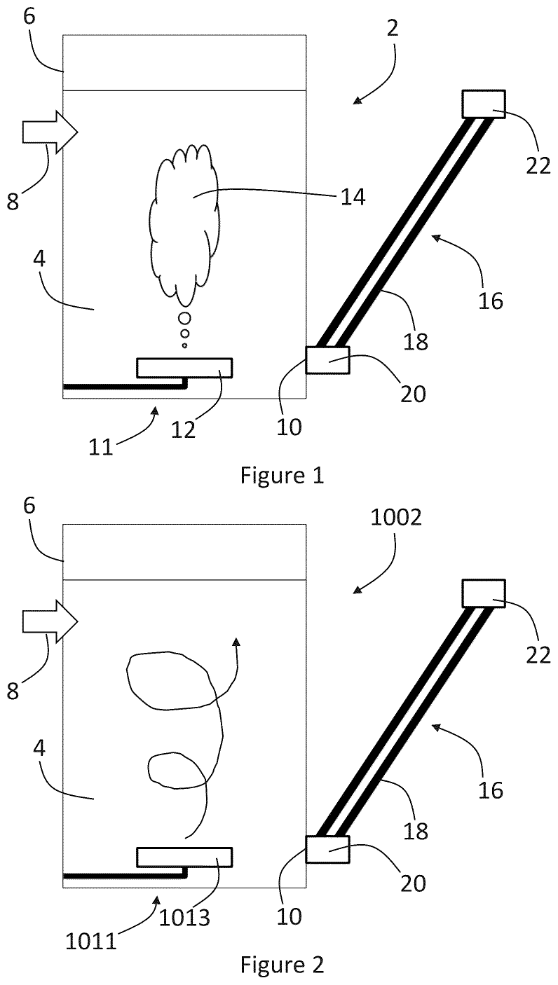

FIG. 1 shows schematically a reaction and separation apparatus according to a first embodiment of the invention;

FIG. 2 shows schematically a reaction and separation apparatus according to a second embodiment of the invention;

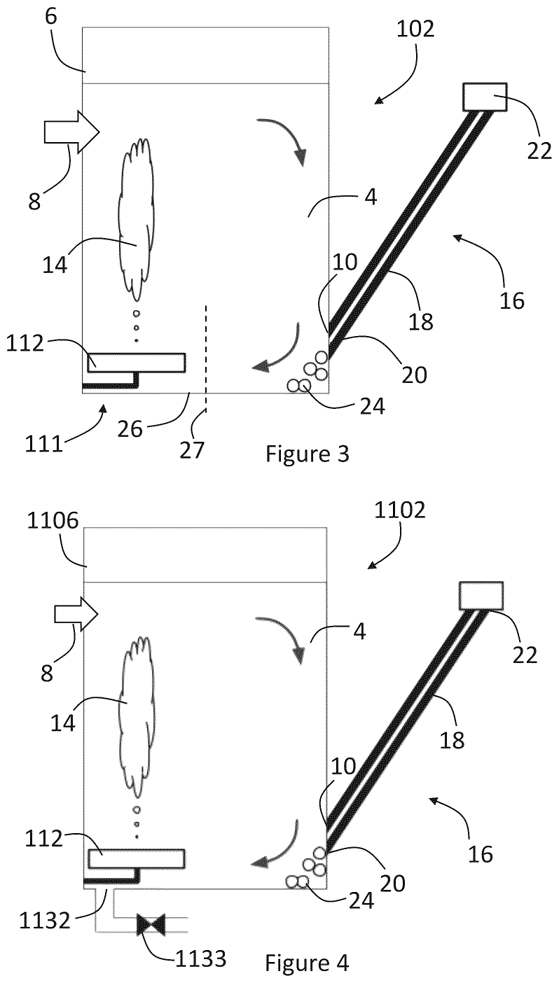

FIG. 3 shows schematically a reaction and separation apparatus according to a third embodiment of the invention;

FIG. 4 shows schematically a reaction and separation apparatus according to a fourth embodiment of the invention;

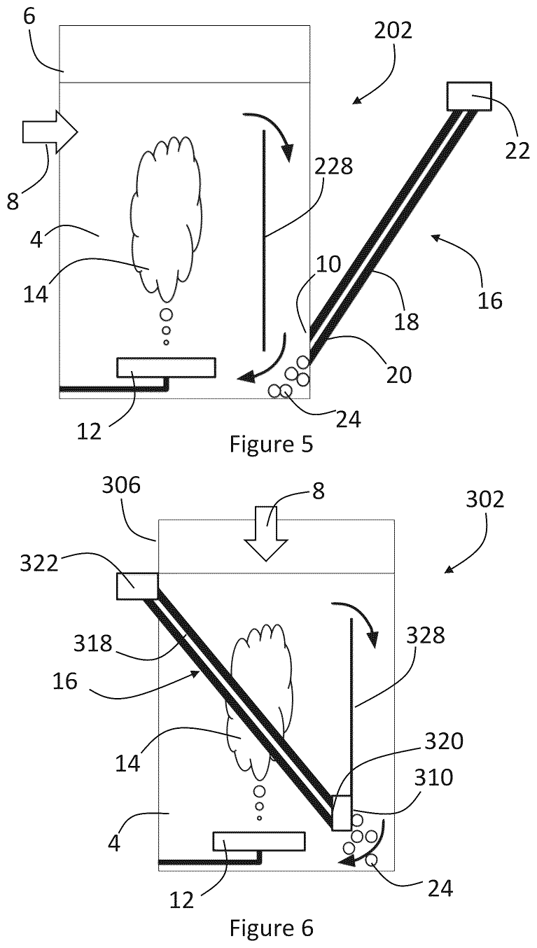

FIG. 5 shows schematically a reaction and separation apparatus according to a fifth embodiment of the invention;

FIG. 6 shows schematically a reaction and separation apparatus according to a sixth embodiment of the invention;

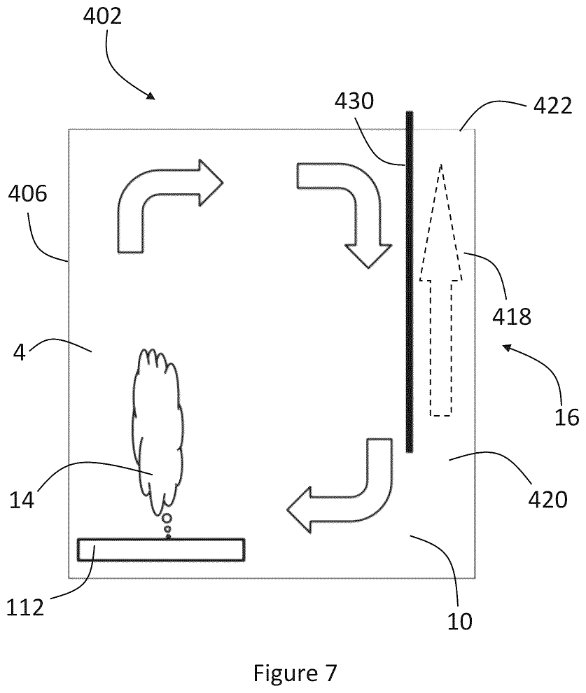

FIG. 7 shows schematically a reaction and separation apparatus according to a seventh embodiment of the invention;

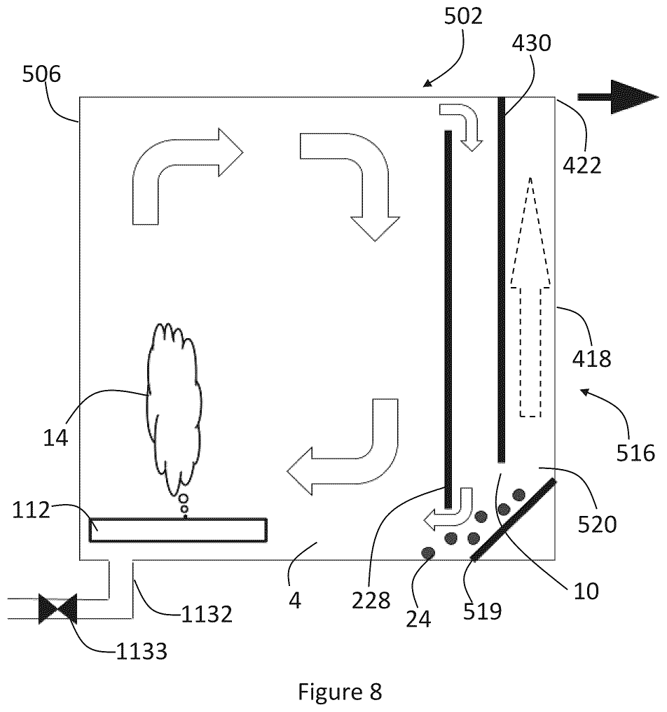

FIG. 8 shows schematically a reaction and separation apparatus according to an eighth embodiment of the invention;

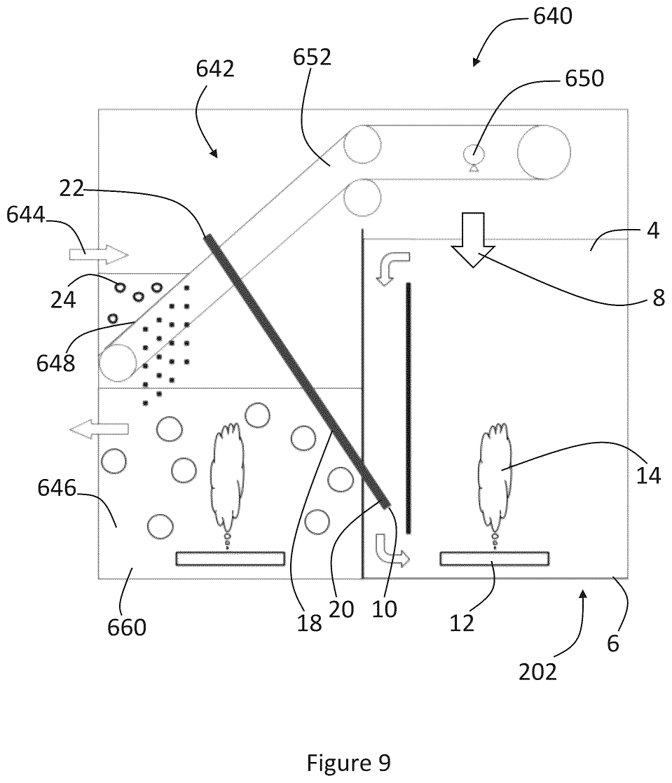

FIG. 9 shows schematically a filtration system according to a ninth embodiment of the invention;

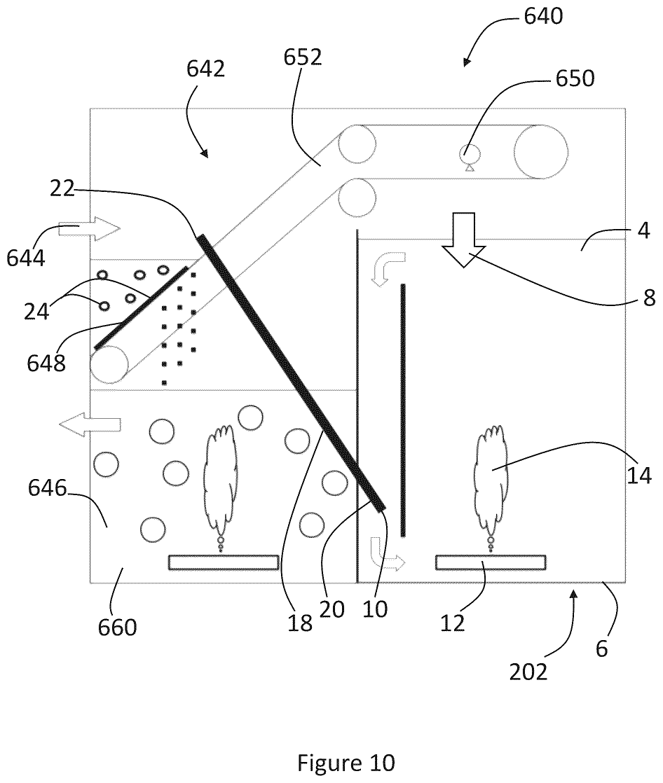

FIG. 10 shows the filtration system of FIG. 9 with build-up of solids on a preparatory filter forming part of the filtration system;

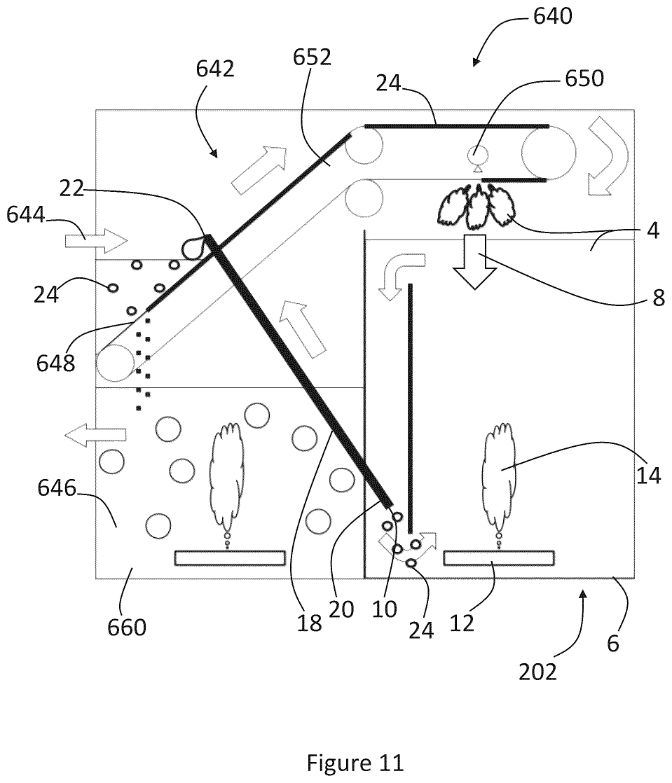

FIG. 11 shows the filtration system of FIG. 9 as solids are dislodged from the preparatory filter and solid-liquid mixture is dispensed into a tank forming part of the reaction and separation apparatus;

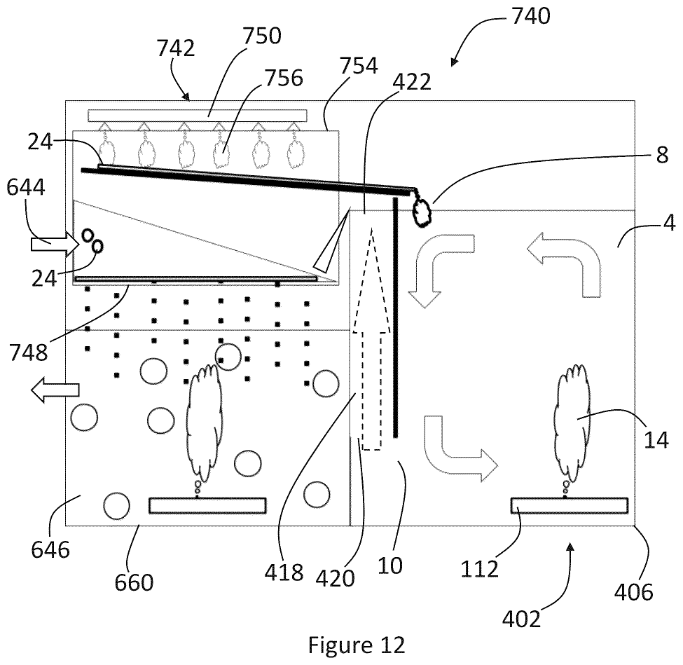

FIG. 12 shows schematically a filtration system according to an tenth embodiment of the invention;

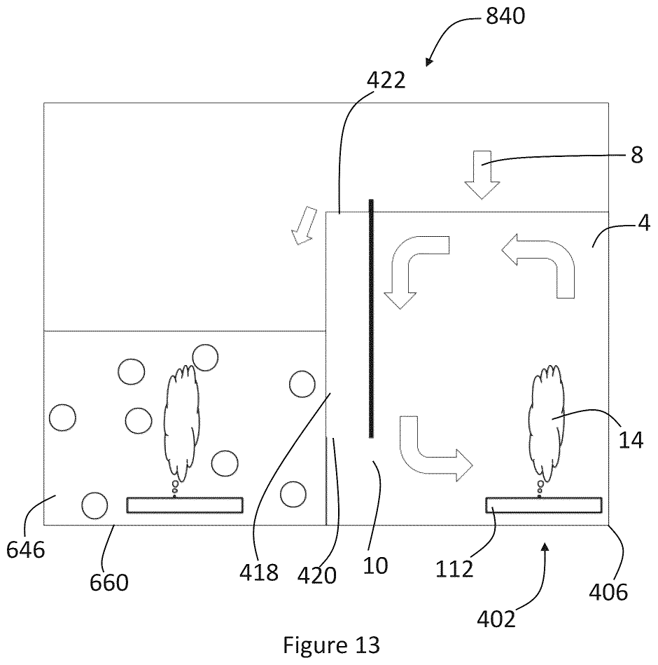

FIG. 13 shows schematically a filtration system according to a eleventh embodiment of the invention;

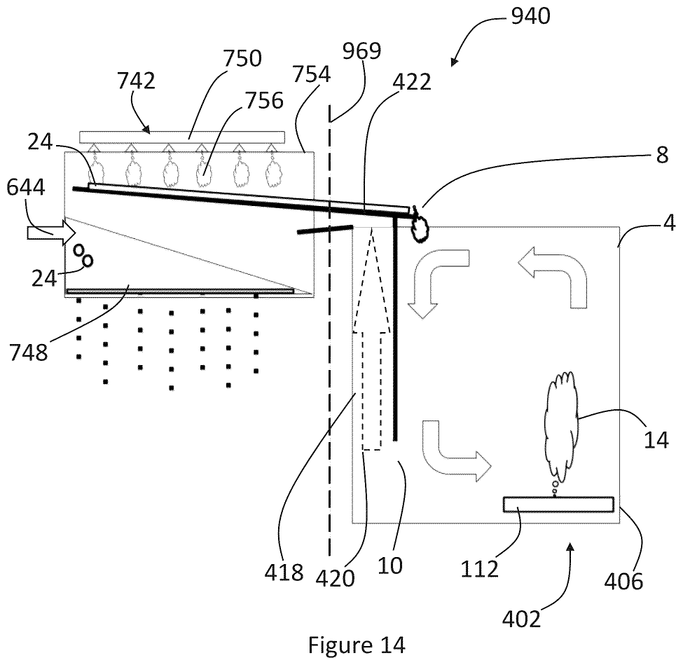

FIG. 14 shows schematically a filtration system according to a twelfth embodiment of the invention;

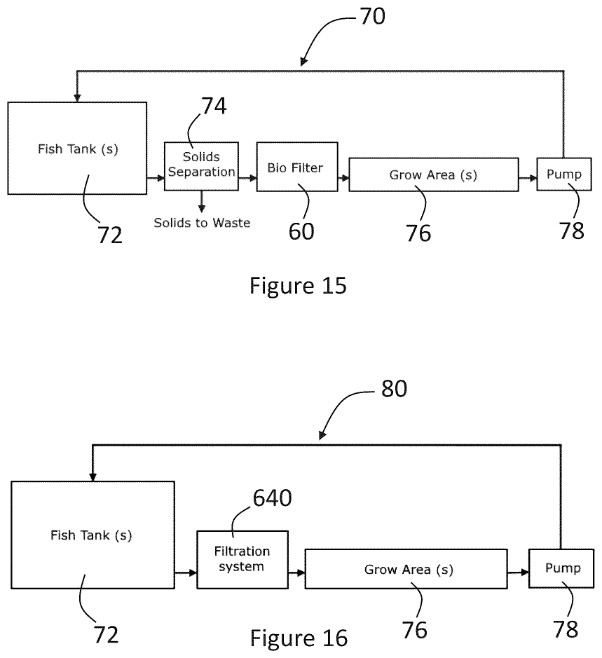

FIG. 15 shows schematically a known aquaponics system comprising a solids separator and separate biofilter;

FIG. 16 shows schematically an aquaponics system comprising a filtration system according to a thirteenth embodiment of the invention;

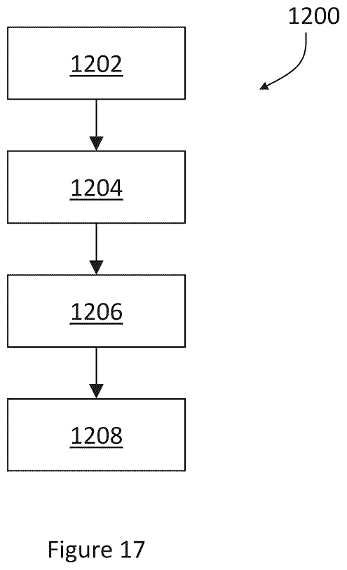

FIG. 17 shows schematically a method for processing a solid-liquid mixture to separate solids from liquid according to a fourteenth embodiment of the invention; and

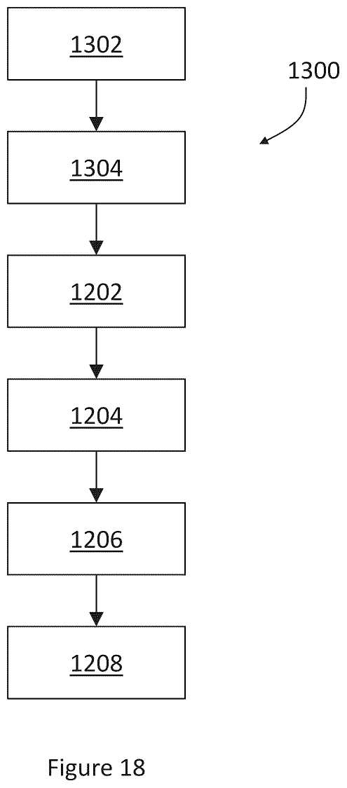

FIG. 18 shows schematically a method for processing an inflow liquid according to a fifteenth embodiment of the invention.

The figures are not necessarily to scale, and certain features and certain views of the figures may be shown exaggerated in scale or in schematic form in the interests of clarity and conciseness.

A reaction and separation apparatus according to a first embodiment of the invention is shown in FIG. 1, and is designated generally by the reference numeral 2.

The reaction and separation apparatus 2 comprises a tank 6, a reaction device 11 and a sedimentation device 16.

The tank 6 comprises an inlet 8 and an outlet 10. The inlet 8 is configured for receiving a solid-water mixture 4 into the tank 6, e.g. connected via a pipe to a solid-water mixture source, while the outlet 10 is configured for permitting water to exit the tank 6.

The reaction device 11 is operable to cause and/or accelerate one or more reactions within the solid-water mixture 4. In this embodiment of the invention, the reaction device 11 comprises an aerator 12 that is operable to release gas 14 into the tank 6 so that it flows through, and mixes with, the solid-water mixture 4.

In particular, the aerator 12 is positioned towards the base of the tank 6 and is operable to release the gas 14 in an upward direction to increase the duration of contact between the released gas 14 and the solid-water mixture 4. The gas 14 may be air, oxygen or an oxygen-rich mixture. Oxygen present in the gas 14 causes growth of microorganisms in the solid-water mixture 4 which then breaks down the solids and release nutrients into the water.

The sedimentation device 16 includes a liquid conduit 18 which has a first end 20 and a second end 22. The first end 20 is configured to be in liquid communication with the outlet 10 while the second end 22 is configured for dispensing water from the liquid conduit 18. In use, the second end 22 is positioned higher than the first end 20 so that the liquid conduit 16 extends from the first end 20 to the second end 20 along an inclined axis relative to the horizontal.

In this embodiment of the invention, the liquid conduit 18 comprises a plurality of lamellar separation tubes (not shown) bundled together so that they extend in parallel to one another between the first and second ends 20, 22. The plurality of lamellar separation tubes provide a plurality of surfaces on which solids may settle, accumulate and then slide down towards the first end 20 of the liquid conduit 18. Further, each tube is configured with an internal diameter sized to encourage laminar flow of fluid through the tube, thereby encouraging laminar flow and minimising turbulence so that settling of solids occurs more rapidly.

Therefore, in use, the reaction and separation apparatus 2 carries out a reaction and separation process in which the reaction and separation apparatus 2 aerates a solid-water mixture 4 and separates solids from water using just a single tank 6. As a result of the configuration of the reaction and separation apparatus 2, nutrient-rich water is dispensed from the second end of the liquid conduit 18, where the water is solids-free or has a low amount of solids 24.

The reaction and separation apparatus 1002 of FIG. 2 is similar in structure and operation to the reaction and separation apparatus 2 of FIG. 1 except that, in this embodiment of the invention, the reaction device 1011 comprises a rotatable stirrer 1013 which stirs the contents of the tank 6, thereby mixing the solid-liquid mixture 4 to accelerate one or more reactions within the solid-liquid mixture 4.

Referring now to FIG. 3, the reaction and separation apparatus 102 differs from the reaction and separation apparatus 2 of FIG. 1 in that the aerator 112 is eccentrically positioned relative to a central axis 27 passing through a base 26 of the tank 6. As with the reaction and separation apparatus 2 of FIG. 1, the aerator 112 is operable to release gas 14 in an upwards direction from its eccentric position so that the flow of gas 14 induces circulation of the solid-water mixture 4 around at least a part of the tank 6 and past the outlet 10.

Circulation of the solid-water mixture 4 past the outlet 10 encourages solids 24, which have settled from the water in the liquid conduit 18 and fallen back towards the first end 20, to be flushed away from the outlet 10 and thereby drawn from the liquid conduit 18 back into the tank 6. Therefore, the reaction and separation apparatus 102 is self-cleaning, in use.

The reaction and separation apparatus 1102 of FIG. 4 is similar in structure and operation to the reaction and separation apparatus 102 of FIG. 3 except that, in this embodiment of the invention, the tank 506 additionally comprises a solids outlet 1132 configured for dispensing solids 24 settled at or towards a base of the tank 1106. This allows settled solids 24 to be removed to avoid them building up at the base of the tank 1106 and risking blockage of the outlet 10. The solids outlet 1132 preferably includes a flow control valve 1133 for selectively permitting and blocking flow out of the tank 1106 via the solids outlet 1132. In particular, the solids outlet 1132 is positioned in the tank 1106 so that it is below the aerator 112 when the reaction and separation apparatus 1102 is in use. This is because solids 24 are most likely to flow to the region of the tank 1106 below the aerator 112 and so positioning the solids outlet 1132 in this location improves the efficacy with which solids 24 may be removed.

The reaction and separation apparatus 202 of FIG. 5 is similar to the reaction and separation apparatus 2 of FIG. 1 except that it further comprises a baffle 228 positioned in the tank 6 to direct the circulating solid-water mixture 4 to flow past the outlet 10. In particular, the baffle 228 extends vertically relative to the base of the tank 6 and the baffle 228 is positioned in the tank 6 to direct the circulating solid-water mixture 4 to flow in a downward direction past the outlet 10. The flow of solid-water mixture 4 past the outlet 10 therefore complements the effect of gravity on the solids 24 settling at the first end 20 so that the solids 24 are more effectively flushed away from the outlet 10 and drawn back into the tank 6.

The baffle 228 is also positioned in the tank 6 between the aerator 12 and the outlet 10. The baffle 228 therefore prevents aeration of water inside the liquid conduit 18 by the aerator 12. This means that the gas 14 remains in the tank 6 to maximise microorganism growth. In addition, the gas 14 remaining in the tank 6 reduces the risk of turbulence inside the liquid conduit 18 that would reduce settling efficiency.

Optionally, the baffle 228 may be re-configurable to change its size or shape to allow a user of the reaction and separation apparatus 202 to adapt the flow of solid-water mixture 4 around the tank 6 based on the specific system parameters, such as flow rate and solid-water mixture composition.

The reaction and separation apparatus 302 of FIG. 6 differs from the reaction and separation apparatus 202 of FIG. 5 in that the liquid conduit 18 is arranged to extend inside and through the tank 306. The first end 320 of the liquid conduit 318 is in water communication with the outlet 310 through the baffle 328. The liquid conduit 318 extends through a region of the tank 306 that the released gas 14 also passes through. The liquid conduit 318 therefore acts as a barrier that disrupts the flow of gas 14 and solid-water mixture 4 to increase turbulence in the tank 6. This promotes mixing of microorganisms throughout the solid-water mixture 4 and distributes gas 14 more evenly through the solid-water mixture 4 to improve the reaction process.

FIG. 7 shows a reaction and separation apparatus 402 wherein the tank 406 and the liquid conduit 418 are configured to have a common wall 430 separating the tank 6 and the liquid conduit 418. The first end 420 of the liquid conduit 418 is in liquid communication with the outlet 10 through the common wall 430.

Therefore, in this embodiment of the invention, the liquid conduit 418 extends from the first end 420 to the second end 422 along a vertical axis rather than at an incline to the horizontal, as in the embodiments shown in FIGS. 1 to 6. It will be appreciated that this embodiment may be modified to position the liquid conduit 418 at an incline relative to the horizontal.

Due to the effect of gravity on solids in the liquid conduit 418, the solid-water mixture comprises a gradually reducing density of solids in the upwards direction. This gradual transition is represented by the arrow drawn with a broken line.

The reaction and separation apparatus 502 of FIG. 8 is similar to the reaction and separation apparatus 402 of FIG. 7. However, in this embodiment of the invention, the tank 506 further comprises a baffle 228 (similarly to the reaction and separation apparatus 202 shown in FIG. 5) and an inclined settling guide 519. The tank also additionally comprises a solids outlet 1132 similarly to the reaction and separation apparatus 1102 of FIG. 4.

As in the reaction and separation apparatus 202 shown in FIG. 5, the baffle 228 is configured to direct the circulating solid-water mixture 4 to flow in a downward direction past the outlet 10 and improve the flushing of settled solids away from the liquid conduit 516 and back into the tank 506. The inclined settling guide 519 further assists this flushing action by causing settled solids 24 to slide directly into the flow of solid-liquid mixture circulating around the baffle 228.

FIGS. 9, 10 and 11 show a filtration system 640 comprising the reaction and separation apparatus 202 (also shown in FIG. 5), a preparatory filter 642 and a biofilter 660.

The preparatory filter 642 comprises a filtration element 648 and a solids removal device 650. More particularly, the filtration element 648 is a belt filter 652 in the form of an endless belt that is driven by a drive motor. In use, the belt filter 652 receives waste water 644, containing suspended solids, from an external source, e.g. a fish tank. The solids content in the waste water 644 may be, for example, 25 mg/ml. The filtration element 648 is configured to separate the waste water 644 into solids 24 and filtered water 646, as shown in FIG. 9. The filtration element 648 may be perforated with holes, which may be 50 μm in diameter. As the solids 24 start to accumulate on the filtration element 648 as shown in FIG. 10, the accumulated solids 24 are transported by the belt filter 652 towards the solids removal device 650.

The solids removal device 650 comprises a water source in the form of a spraying device operable to spray washing water (not shown) at the filtration element 648 to dislodge the accumulated solids 24 from the filtration element 648 and provide a solid-water mixture 4 that is dispensed into the tank 6 via the inlet 8, as shown in FIG. 9. The solid-water mixture comprises a mixture of the washing water and the dislodged solids 24. The spraying device may be configured to spray the washing water periodically or on demand in response to an operator input. The spraying device may be configured to spray the washing water in response to a sensor detecting that a certain amount of solids 24 have accumulated on the filtration element 648, e.g. a rise in water level in the preparatory filter 642.

Using the reaction and separation apparatus 202, the solid-water mixture undergoes a reaction and separation process, and the liquid conduit 18 dispenses water from its second end 22. The liquid conduit 18 is configured to dispense the water from its second end 22 upstream of the belt filter 652 so that the water dispensed from the liquid conduit 18 may undergo further filtration by the belt filter 652, as shown in FIG. 11. The filtered water 646 is then dispensed into the biofilter 660 where ammonia is processed into nitrates. It is to be understood that the biofilter 660 is distinct from the settling tank of known two-tank reaction and separation systems. The settling tank of known two-tank reaction and separation systems functions to settle out solids. However, in the filtration system 640, this function is performed by the liquid conduit 18 rather than a separate tank. Meanwhile, the biofilter 660 performs a different function, which is the processing of ammonia into nitrates.

After undergoing processing by the biofilter 660, the processed water then exits, or is collected from, the filtration system 640 for further use, such as watering crops.

FIG. 12 shows a filtration system 740 that differs from the filtration system 640 shown in FIGS. 9, 10 and 11 in that it comprises the reaction and separation apparatus 402 (also shown in FIG. 7) and in that the filtration element 748 is a drum filter 754 rather than a belt filter.

Similarly to the filtration system 640 when in use, the drum filter 754 receives a waste water 644 from an external source and the drum filter 754 is configured to separate the waste water 644 into solids 24 and filtered water 646.

The solids removal device 750 comprises a water source in the form of a spraying device operable to spray washing water 756 at the filtration element 643 to dislodge the solids 24 from the filtration element 748 and provide a solid-water mixture 4 that is dispensed into the tank 406 via the inlet 8. The solid-water mixture comprises a mixture of the washing water 756 and the dislodged solids 24.

Using the reaction and separation apparatus 402, the solid-water mixture undergoes a reaction and separation process, and the liquid conduit 418 dispenses water from its second end 422. The liquid conduit 418 is configured to dispense water from its second end 422 upstream of the drum filter 754 so that the water dispensed from the liquid conduit 418 may undergo further filtration by the drum filter 754. The filtered water 646 is then dispensed into the biofilter 660 where ammonia is processed into nitrates. After undergoing processing by the biofilter 660, the processed water then exits, or is collected from, the filtration system 740 for further use, such as watering crops.

FIG. 13 shows a further filtration system 840 comprising only the reaction and separation apparatus 402 (also shown in FIG. 7) and the biofilter 660 for processing ammonia into nitrates. After the reaction and separation process by the reaction and separation apparatus 402, the liquid conduit 418 is configured to dispense liquid from its second end 422 into the biofilter 660.

FIG. 14 shows another filtration system 940 comprising only the reaction and separation apparatus 402 (also shown in FIG. 7) and the preparatory filter 742 (also shown in FIG. 12). In this embodiment of the invention, the area below the drum filter 748 could be of an “open frame” design and filtered water could be allowed to fall directly back to a pond or tank forming part of an aquaponics system, for example.

To assist with the filtered water falling directly where it is needed, the drum filter 748 is separate from the reaction and separation apparatus 402. The dashed line 969 indicates this separation and is representative of variable lengths of connecting pipework.

In a similar embodiment of the invention, filtered water dispensed from the drum filter 748 flows to a collecting chamber (not shown) to be routed back to an aquaponics system, for example.

Referring now to FIG. 15, a prior art aquaponics system 70 is shown. The prior art aquaponics system comprises a fish tank 72, a conventional solids separator system 74, a biofilter 60, a grow area 76 and a pump 78. Waste water from the fish tank 72 is fed into the conventional solids separator system 74 to separate solids from water. The solids are designated as waste, and the separated water is then fed to the separate biofilter 60 where the ammonia is processed to nitrates so that the water can be used for watering plants in the grow area 76 without ammonia harming the plants. The pump 78 then cycles excess water for reuse in the fish tank 72.

FIG. 16 shows an aquaponics system 80 according to the invention. The aquaponics system 80 comprises the filtration system 640 (shown in FIGS. 9 to 11), rather than the separate conventional solids separator system 74 and biofilter 60 required by the prior art aquaponics system 70. The filtration system 640 improves the performance and sustainability of the aquaponics system 80, in comparison to the prior art aquaponics system 70, in a number of ways. For example:
the amount of solids wasted may be greatly reduced, if not eliminated, by providing aeration of the solid-water mixture generated from the fish tank waste water;
any washing water used by the preparatory filter 642 may be retained in the system to form part of the water subsequently fed to the grow area 76;
nitrogen runoff is prevented by way of the biofilter 660, thereby avoiding the harmful dumping of nitrogen rich water into sewers or onto land; and
the water fed to the grow area 76 is rich in nutrients, such as iron, potassium, phosphorus, as a result of microorganisms breaking down the solids (this aspect is particularly beneficial in view of the unsustainability of phosphorous production).

The filtration system 540 may additionally reduce the space requirements and capital costs associated with aquaponics systems. The aquaponics system 80 is also easier to install than known aquaponics systems by virtue of having fewer individual units to install.

FIG. 17 shows a method 1200 by which a solid-water mixture may be processed using a reaction and separation apparatus according to the invention, such as any one of those shown in FIGS. 1 to 8. The method 1200 comprises the steps of:
1202) providing solid-water mixture into the tank;
1204) causing and/or accelerating one or more reactions within the solid-liquid mixture within the tank using the reaction device;
1206) adding more solid-water mixture into the tank to cause the aerated solid-water mixture to exit the tank via the liquid conduit; and
1208) dispensing water from the second end of the liquid conduit.

FIG. 18 shows a method 1300 by which a waste water may be processed using a filtration system according to the invention, such as any one of those shown in FIGS. 9 to 12.

The method 1300 comprises the initial steps of:
1302) providing waste water into the preparatory filter; and
1304) separating the waste water into a solid-water mixture and a filtered water using the preparatory filter.

The method 1300 then continues in accordance with the method 1200, shown in FIG. 17.

The invention addresses many environmental and sustainability issues as follows:
Soil nutrient depletion is resolved through the capture and processing of solids from waste in order to obtain nutrients for promoting crop growth. Otherwise the waste would simply be released into water courses.
Water course contamination takes place when farmers apply nutrients to their fields and then rain causes excess nutrients to run into water courses, causing nutrient pollution or nitrogen runoff. This can happen when aquaculture and aquaponic systems release their filter waste into the environment. By capturing and processing solids from waste, the invention prevents excess nutrients (e.g. nitrogen, phosphorus) from being released into water courses.
The invention may be used to retain and process solids in municipal sewage processing systems, allowing processing of nutrient-rich water into usable products. For example, struvite could be produced from water that is rich in nitrogen and phosphorus (two of the main pollutants). This would then greatly reduce wasted nutrients and nutrient pollution by capturing these nutrients from the water before the water is released into the environment.
Phosphorus is a nutrient commonly added to hydroponic and aquaponic systems. “Peak Phosphorus” is a term used in recent times to highlight how mining phosphorus rock can be unsustainable. Phosphorus supplementation would be greatly reduced by the invention, as phosphorus from fish feed or waste would be captured, processed and retained within the hydroponic and aquaponic systems.
The invention limits synthetic nitrogen manufacturing emissions and nitrogen pollution that arises due to nitrous oxide emissions from fertiliser use by providing an ecological way of producing nitrogen for agricultural applications with greatly reduced greenhouse gas emissions.

It will be appreciated that any aforementioned numerical value is merely intended to help illustrate the working of the invention and may vary depending on the requirements of the invention.

The listing or discussion of an apparently prior published document or apparently prior published information in this specification should not necessarily be taken as an acknowledgement that the document or information is part of the state of the art or is common general knowledge.

Preferences and options for a given aspect, feature or parameter of the invention should, unless the context indicates otherwise, be regarded as having been disclosed in combination with any and all preferences and options for all other aspects, features and parameters of the invention.

1. A filtration system comprising a reaction and separation apparatus for processing a solid-liquid mixture to separate solids from liquid, the reaction and separation apparatus comprising:
a tank comprising an inlet and an outlet, the inlet configured for receiving the solid-liquid mixture into the tank, the outlet configured for permitting liquid to exit the tank; and
a sedimentation device including a liquid conduit, the liquid conduit having a first end and a second end, the first end configured to be in liquid communication with the outlet, the second end configured for dispensing liquid from the liquid conduit, wherein the second end is positioned higher than the first end so that the liquid conduit extends from the first end to the second end along a vertical axis or along an inclined axis relative to the horizontal,
wherein the filtration system further comprises a preparatory filter configured to, in use, receive an inflow liquid from an external source and separate the inflow liquid into the solid-liquid mixture and a filtered liquid, wherein the preparatory filter is configured to dispense the solid-liquid mixture into the tank via the inlet.

2. A filtration system according to claim 1, wherein the liquid conduit includes at least one tube or at least one lamellar separation element.

3. (canceled)

4. A filtration system according to claim 1, wherein the reaction and separation apparatus further comprises a reaction device operable to cause and/or accelerate one or more reactions within the solid-liquid mixture within the tank.

5. A filtration system according to claim 4, wherein the reaction device comprises a mixer positioned in or relative to the tank so that, in use, the mixer is operable to mix the solid-liquid mixture within the tank; or an aerator for releasing a gas, the aerator positioned in or relative to the tank so that, in use, the aerator is operable to release the gas into the tank.

6. (canceled)

7. (canceled)

8. A filtration system according to claim 4, wherein the reaction device is positioned in or relative to the tank so that, in use, the reaction device is operable to induce circulation of the solid-liquid mixture around at least a part of the tank and past the outlet.

9. (canceled)

10. A filtration system according to claim 8, further comprising a baffle positioned in the tank to direct the circulating solid-liquid mixture to flow past the outlet.

11. A filtration system according to claim 10, wherein the baffle is positioned in the tank to direct the circulating solid-liquid mixture to flow in a downward direction past the outlet.

12. A filtration system according to claim 10, wherein the baffle extends vertically or substantially vertically relative to a base of the tank.

13. A filtration system according to claim 10, wherein the baffle is re-configurable to change its size or shape.

14. A filtration system according to claim 10, wherein the reaction device comprises an aerator for releasing a gas, the aerator positioned in or relative to the tank so that, in use, the aerator is operable to release the gas into the tank, wherein the baffle is positioned in the tank between the aerator and the outlet to prevent aeration of liquid inside the liquid conduit by the aerator.

15. A filtration system according to claim 1, wherein the tank and the liquid conduit are configured to have a common wall separating the tank and the liquid conduit, and the first end of the liquid conduit is configured to be in liquid communication with the outlet through the common wall.

16. (canceled)

17. A filtration system according to claim 1, wherein the tank further comprises a solids outlet configured for dispensing solids settled at or towards a base of the tank.

18. A filtration system according to claim 1, wherein the liquid conduit is configured to dispense liquid from the second end upstream of the preparatory filter so that the liquid dispensed from the liquid conduit may undergo filtration by the preparatory filter.

19. A filtration system according to claim 1, wherein the preparatory filter comprises a filtration element and a solids removal device, the filtration element configured to separate the inflow liquid into solids and the filtered liquid, the solids removal device operable to dislodge solids from the filtration element so that the solids may be mixed with a liquid to provide a solid-liquid mixture for dispensing into the tank via the inlet.

20. A filtration system according to claim 19, wherein the solids removal device comprises a liquid source operable to direct a flow of washing liquid at the filtration element to dislodge the solids from the filtration element to provide a solid-liquid mixture that is dispensed into the tank via the inlet into the tank, wherein the solid-liquid mixture comprises a mixture of the washing liquid and the dislodged solids.

21. A filtration system according to claim 19, wherein the filtration element is a belt filter or a drum filter.

22. A filtration system according to claim 1, further comprising a biofilter for processing ammonia into nitrates, wherein the preparatory filter is configured to dispense the filtered liquid into the biofilter.

23. A reaction and separation apparatus for processing a solid-liquid mixture to separate solids from liquid, the reaction and separation apparatus comprising:
a tank comprising an inlet and an outlet, the inlet configured for receiving the solid-liquid mixture into the tank, the outlet configured for permitting liquid to exit the tank;
a reaction device operable to cause and/or accelerate one or more reactions within the solid-liquid mixture within the tank; and
a sedimentation device including a liquid conduit, the liquid conduit having a first end and a second end, the first end configured to be in liquid communication with the outlet, the second end configured for dispensing liquid from the liquid conduit, wherein the second end is positioned higher than the first end so that the liquid conduit extends from the first end to the second end along a vertical axis or along an inclined axis relative to the horizontal.

24. A method for processing an inflow liquid using a filtration system according to claim 1, the method comprising the steps of:
providing inflow liquid into the preparatory filter;
separating the inflow liquid into a solid-liquid mixture and a filtered liquid using the preparatory filter;
providing the solid-liquid mixture into the tank;
causing and/or accelerating one or more reactions within the solid-liquid mixture within the tank using the reaction device;
adding more solid-liquid mixture into the tank to cause the aerated solid-liquid mixture to exit the tank via the liquid conduit; and
dispensing liquid from the second end of the liquid conduit.

25. A method for processing a solid-liquid mixture to separate solids from liquid using a reaction and separation apparatus according to claim 23, the method comprising the steps of:
providing solid-liquid mixture into the tank;
causing and/or accelerating one or more reactions within the solid-liquid mixture within the tank using the reaction device;
adding more solid-liquid mixture into the tank to cause the aerated solid-liquid mixture to exit the tank via the liquid conduit; and
dispensing liquid from the second end of the liquid conduit.
